(19) United States
(12) Patent Application Publication
(10) Pub. No.: US 2014/0097926 A1
(43) Pub. Date: Apr. 10, 2014

(54) INDUCTION DEVICE

(71) Applicant: Kabushiki Kaisha Toyota Jidoshokki, Kariya-shi (JP)

(72) Inventor: Hiroshi ONO, Aichi-ken (JP)

(73) Assignee: Kabushiki Kaisha Toyota Jidoshokki, Kariya-shi (JP)

(21) Appl. No.: 14/041,734

(22) Filed: Sep. 30, 2013

(30) Foreign Application Priority Data
Oct. 5, 2012 (JP) 2012-223257

(51) Int. Cl. H01F 17/00

(52) U.S. Cl. CPC H01F 17/0013
USPC 336/200

(57) ABSTRACT

The induction device includes a magnetic core and a coil. The coil is formed around the magnetic core by laminating and electrically connecting together a plurality of multilayer wiring boards. Each multilayer wiring board has a hole through which the magnetic core is inserted. Each multilayer wiring board includes a first outer conductor, an inner conductor and a second outer conductor that are laminated together with an insulating layer disposed between the first outer conductor and the inner conductor and also the insulating layer disposed between the inner conductor and the second outer conductor. The first outer conductor, the inner conductor and the second outer conductor are formed around the hole of the multilayer wiring board. The first outer conductor and the second outer conductor are connected to the inner conductor.

### BACKGROUND OF THE INVENTION

The present invention relates to an induction device.

There has been publicly known an induction device such as a reactor or transformer in which a conductive wire is wound around a magnetic core (See Japanese Unexamined Patent Application Publication No. 4-144212). Some induction devices are of a multilayer type that uses as a coil a multilayer wiring board having a plurality of wiring sheets which are laminated together and each having a spiral conductor patterned on one or both surfaces of an insulating sheet.

Since increasing the number of layers of the conductors is technically limited, the number of turns of the conductor in each layer is increased to increase the number of turns of the coil in the multilayer wiring board. In such a case, the multilayer wiring board tends to be increased in width (or in the radial dimension of the coil) with an increase in the number of turns of the coil.

To allow a high current to flow through a coil used in the induction device, the cross-sectional area of the conductor of the coil needs to be increased. In the case of the multilayer wiring board, an increase of the cross-sectional area of the conductor is accomplished by increasing the width of the conductor of each layer. However, the multilayer wiring board tends to be increased in width (or in the radial dimension of the coil) with an increase in the current passing through the conductor.

Thus, the multilayer wiring board tends to be increased in width. The induction device, which uses the multilayer wiring board as the coil, has difficulty in avoiding an increase of the size of the induction device. The present invention is directed to an induction device whose size is reduced in radial dimension of a coil and whose number of turns of the coil in the multilayer wiring board is easily increased.

### SUMMARY OF THE INVENTION

In accordance with an aspect of the present invention, the induction device includes a magnetic core and a coil. The coil is formed around the magnetic core by laminating and electrically connecting together a plurality of multilayer wiring boards. Each multilayer wiring board has a hole through which the magnetic core is inserted. Each multilayer wiring board includes a first outer conductor, an inner conductor and a second outer conductor that are laminated together with an insulating layer disposed between the first outer conductor and the inner conductor and also the insulating layer disposed between the inner conductor and the second outer conductor. The first outer conductor, the inner conductor and the second outer conductor are formed around the hole of the multilayer wiring board. The first outer conductor and the second outer conductor are connected to the inner conductor.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is an exploded perspective view showing a transformer according to an embodiment of the present invention;

FIG. 2 is a perspective view showing the transformer of FIG. 1;

FIG. 3 is a schematic configuration view showing a multilayer wiring board of the transformer of FIG. 1;

FIG. 4A is a partial top view showing the transformer of FIG. 1; and

FIG. 4B is a partial top view showing a transformer according to a background art.

### DETAILED DESCRIPTION OF THE EMBODIMENTS

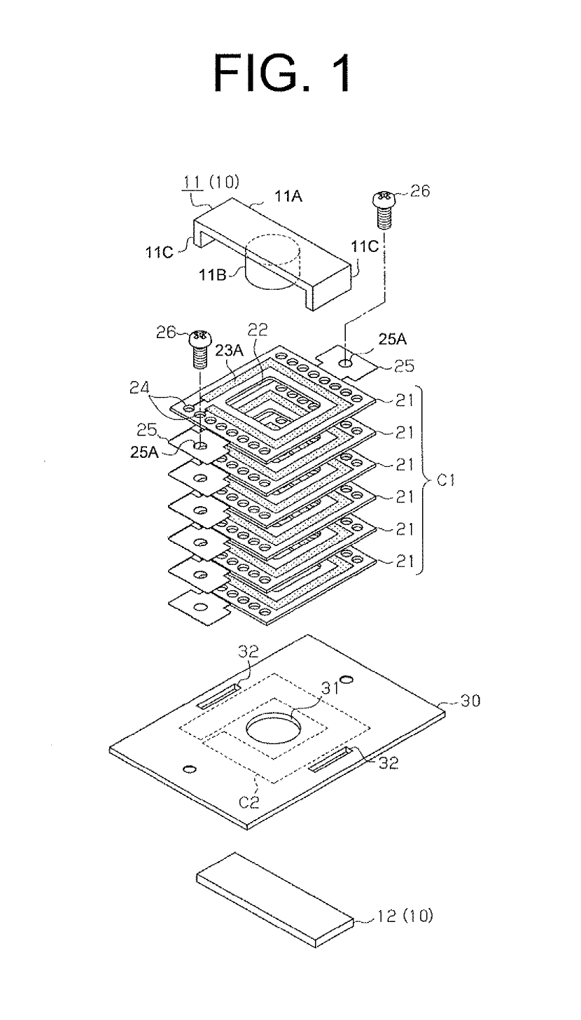

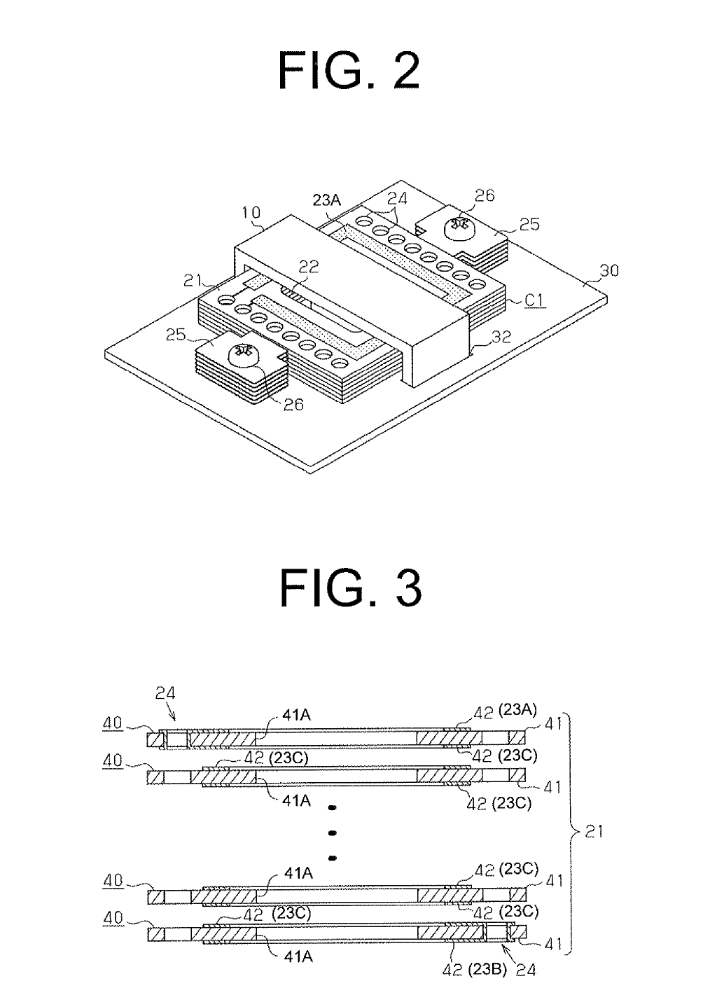

The following will describe the transformer according to the embodiment of the present invention with reference to the accompanying drawings. Referring to FIGS. 1 and 2, the transformer includes a magnetic core 10, a primary coil C1 and a secondary coil C2. Both coils C1 and C2 are wound around the magnetic core 10.

The magnetic core 10 is of an E-1 core having an E-shaped core 11 and an I-shaped core 12. The E-shaped core 11 includes a rectangular plate 11A, a center leg 11B that extends from the center of the lower surface of the plate 11A, and outer legs 11C that extend from the lower surface of the plate 11A at the opposite ends thereof. The I-shaped core 12 is formed in a rectangular plate. In the magnetic core 10, the ends of the center leg 11B and the outer legs 11C of the E-shaped core 11 are joined to the upper surface of the I-shaped core 12 thereby to form a closed magnetic circuit.

The transformer further includes an insulating substrate 30. The secondary coil C2 is formed by a copper sheet and patterned on the lower surface of the insulating substrate 30. As shown in FIG. 1, the insulating substrate 30 has a first hole 31 through which the center leg 11B of the E-shaped core 11 is inserted and second holes 32 through which the outer legs 11C of the E-shaped core 11 are inserted. The secondary coil C2 is formed so as to surround the first hole 31 of the insulating substrate 30, or to be wound around the center leg 11B of the E-shaped core 11 inserted through the first hole 31.

As shown in FIGS. 1 and 2, the primary coil C1 is arranged on the upper surface of the insulating substrate 30. The primary coil C1 is formed by laminating and electrically connecting six multilayer wiring boards 21 together in thickness direction thereof.

Each multilayer wiring board 21 of the primary coil C1 is formed in a rectangular plate having at the center thereof a hole 22 through which the center leg 11B of the E-shaped core 11 is inserted. The multilayer wiring board 21 has on the upper surface thereof a first outer conductor 23A that is wound around the hole 22 and on the lower surface thereof a second outer conductor 23B that is wound around the hole 22 (refer to FIG. 3). In addition, the multilayer wiring board 21 has therein fourteen inner conductors 23C that are wound around the hole 22 and laminated together (refer to FIG. 3).

The upper and lower conductors of each multilayer wiring board 21 are connected together in series via through holes 24 and hence electrically connected together. Thus, each multilayer wiring board 21 has the one first outer conductor 23A, the one second outer conductor 23B and the fourteen inner conductors 23C thereby to form a coil of sixteen turns having sixteen layers in each of which the conductor is wound around the hole 22. Each multilayer wiring board 21 has on the opposite sides thereof a pair of external terminals 25 each having a hole 25A. The paired external terminals 25 of each multilayer wiring board 21 are electrically connected to the first outer conductor 23A and the second outer conductor 23B, respectively.

As shown in FIG. 3, the multilayer wiring board 21 is formed by unitarily laminating a plurality of wiring sheets 40 via insulating adhesives (not shown) that serve as insulating layers between any two adjacent wiring sheets 40. Each wiring sheet 40 is formed by patterning of conductors 42 on both surfaces of an insulating sheet 41 that serves as an insulating layer. Each conductor 42 is formed by a copper sheet that is wound around a hole 41A formed at the center of the insulating sheet 41. Electrical conduction among the conductors 42 of each wiring sheet 40 is ensured via through holes 24 located on the opposite sides of the wiring sheet 40. The surface of the multilayer wiring board 21 is coated with an insulating rein (not shown).

In the multilayer wiring board 21, the conductor 42 located on the upper surface of the uppermost wiring sheet 40 forms the first outer conductor 23A, the conductor 42 located on the lower surface of the lowermost wiring sheet 40 forms the second outer conductor 23B, and the other conductors 42 form the inner conductors 23C.

In each multilayer wiring board 21, electric current is passed between the conductors of each wiring sheet 40 via the through hole 24 and also passed to form a coil of one turn for each pair of two adjacent through holes 24. For example, electric current flowing from one external terminal 25 into the multilayer wiring board 21 firstly flows through the first outer conductor 23A turning around the hole 41A substantially, and then flows via one through hole 24 to the inner conductor 23C that is adjacent to and just below the first outer conductor 23A. The electric current then flows through the inner conductor 23C turning around the hole 41A substantially, and then flows via one through hole 24 to the inner conductor 23C that is adjacent to and below the above inner conductor 23C. Such flow of the electric current is repeated for the fourteen inner conductors 23C. The electric current flowed through the lowermost inner conductor 23C flows via one through hole 24 to the second outer conductor 23B that is adjacent to and just below the lowermost inner conductor 23C, and then flows through the second outer conductor 23B turning around the hole 41A substantially before flowing to the other external terminal 25.

As shown in FIGS. 1 and 2, the six multilayer wiring boards 21 are united into the primary coil C1 by bolts 26 inserted through the holes 25A of the external terminals 25 of the multilayer wiring boards 21 and also the hole in the insulating substrate 30 thereby to fix the primary coil C1 to the insulating substrate 30. The multilayer wiring boards 21 of the primary coil C1 are electrically connected together via the bolts 26 inserted through the holes 25A of the external terminals 25.

It is noted that the primary coil C1 including the six multilayer wiring boards 21 is formed by connecting three pairs of multilayer wiring boards 21 in series, the multilayer wiring boards 21 of each pair being connected in parallel. Thus, the primary coil C1 is wound or formed around the center leg 11B of the E-shaped core 11 inserted through the holes 22 of the respective multilayer wiring boards 21. More specifically, the primary coil C1 includes two coils each having forty-eight turns (i.e. one (turn/layer)*sixteen (layers/sheet)*three (sheets)) connected in parallel.

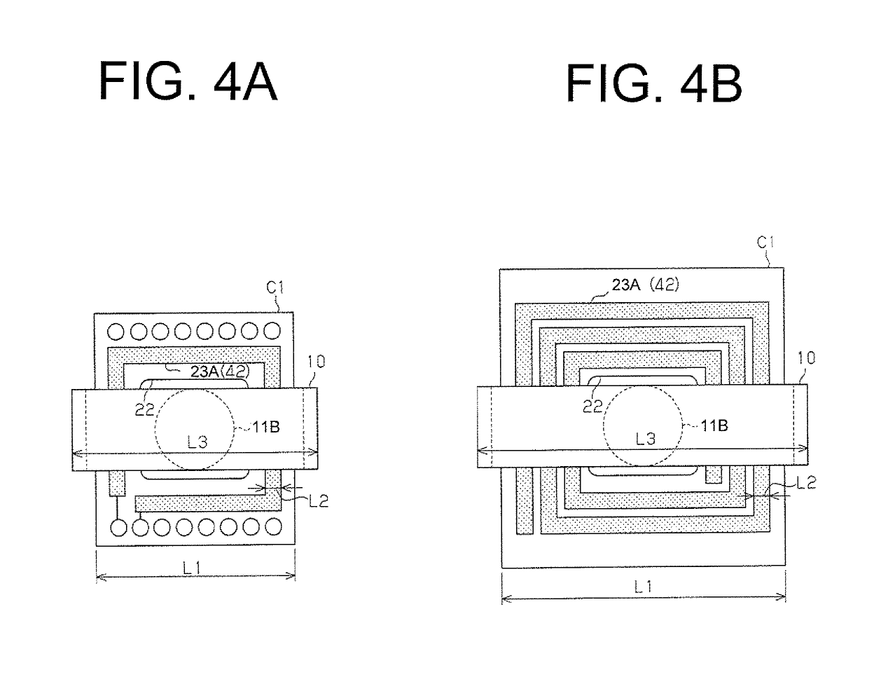

The following will describe the operation of the transformer of the present embodiment. The description is given using an example wherein the multilayer wiring boards each having sixteen layers of conductors form a primary coil of forty-eight turns and in comparison with a conventional structure shown in FIG. 4B.

In the conventional structure of FIG. 4B, a primary coil C1 of forty-eight turns is formed from a single multilayer wiring board by increasing the number of turns of conductor 42 of each layer of a multilayer wiring board, specifically, increasing the number of turns of the conductors 42 to three spiral turns (i.e. three (turns/layer)*sixteen (layers/sheet)*one (sheet)=forty-eight (turns)). In this case, the width L1 of the multilayer wiring board (or the radial dimension of the coil) is set so as to allow radial lamination of three turns of conductors 42.

In the transformer of the present embodiment, on the other hand, the primary coil C1 is formed by laminating six multilayer wiring boards 21 and connecting three of the six multilayer wiring boards 21 in series. As a result, a coil of forty-eight turns is formed so that the number of turns of conductors of each layer of the multilayer wiring boards 21 is one as shown in FIG. 4A (i.e. one (turn/layer)*sixteen (layers/sheet)*three (sheets)=forty-eight (turns)). In this case, the width L1 of the multilayer wiring board only needs to be set so as to allow arrangement of one turn of conductor 42. Therefore, the width L1 of the multilayer wiring board of the present embodiment is reduced considerably as compared to that of the conventional structure.

In order to allow a high current to pass through the primary coil C1, the cross-sectional area of the conductors of the primary coil C1 that includes a coil of forty-eight turns needs to be increased. To increase such cross-sectional area, in the present embodiment, three multilayer wiring boards 21 are connected in parallel to the above-described three multilayer wiring boards 21 connected in series, respectively. Thus, the cross-sectional area of the primary coil C1 is substantially doubled.

Therefore, when a predetermined cross-sectional area of conductors of a coil is ensured, width L2 of each conductor 42 of the present embodiment is reduced to half in comparison with that of the conventional structure. The reduction of the width L2 of each conductor 42 enables further reduction of the width L1 of the multilayer wiring board 21.

Using the primary coil C1 formed by laminating a plurality of multilayer wiring boards 21 and connecting the multilayer wiring boards 21 in series or in parallel, the width L1 of the multilayer wiring board is reduced. Therefore, reduction in the size of the transformer (or in the radial dimension of the primary coil C1) is easily accomplished. The primary coil C1 of the present embodiment wherein the multilayer wiring boards 21 are laminated together has an increased thickness as compared to that of the conventional structure. Since the extent of the increase in the thickness of the multilayer wiring boards 21 is less than that of the decrease in the width L1 of the multilayer wiring boards 21, however, the transformer is reduced in size as a whole.

The transformer of the present embodiment has the following advantageous effects.

(1) The transformer includes the magnetic core 10, the primary coil C1 and the secondary coil C2. Both coils C1 and C2 are formed around the magnetic core 10. The primary coil C1 is formed by laminating and electrically connecting together the multilayer wiring boards 21. Each multilayer wiring board 21 has a hole 22 through which the magnetic core 10 is inserted. Each multilayer wiring board 21 includes a first outer conductor 23A, an inner conductor 23C and a second outer conductor 23B that are laminated together with an insulating layer disposed between any two adjacent conductors 23A, 23C and 23B. The first outer conductor 23A, the inner conductor 23C and the second outer conductor 23B are formed around the hole 22 of the multilayer wiring board 21. The first outer conductor 23A and the second outer conductor 23B are connected to the inner conductor 23C. The transformer thus constructed enables the width L1 of the multilayer wiring board 21 of the primary coil C1 to be reduced. Therefore, the transformer is easily reduced in size. In addition, the number of turns in the primary coil C1 is easily increased by electrically connecting the multilayer wiring boards 21 together.
(2) The reduced width L1 of the multilayer wiring board 21 of the primary coil C1 shown in FIG. 4A can make the length L3 of the magnetic core 10 (or the radial dimension of the coil) to be reduced, thereby reducing the magnetic reluctance of the magnetic core 10.
(3) In the structure wherein at least two multilayer wiring boards 21 of the primary coil C1 are connected in series, the number of turns of the primary coil C1 is increased as a whole while the number of turns of the conductor in each layer of the multilayer wiring board 21 is prevented from being increased. Particularly when the number of turns of the primary coil C1 is desired to be increased, the width L1 of the multilayer wiring board 21 is set small.
(4) In the structure wherein at least two multilayer wiring boards 21 of the primary coil C1 are connected in parallel, the cross-sectional area of the primary coil C1 is increased substantially while the width L2 of the conductor in each layer of the multilayer wiring board 21 is prevented from being increased. Particularly when a high current is desired to be passed through the primary coil C1, the width L1 of the multilayer wiring board 21 is set small.
(5) Each multilayer wiring board 21 includes the first outer conductor 23A, the second outer conductor 23B and at least the one inner conductor 23C, or three or more conductors in total. In addition, the primary coil C1 is formed by laminating the multilayer wiring boards 21 each having three or more conductors. In the primary coil C1, the number of laminations of wiring boards of the primary coil C1 is reduced as compared to a primary coil formed by laminating wiring boards each having only one or two layers of conductors.
(6) In the multilayer wiring board 21 wherein the first outer conductor 23A and the second outer conductor 23B are electrically connected to the inner conductors 23C via the through holes 24, the multilayer wiring board 21 is easily manufactured as compared to the structure wherein solder is used for electrical connection of the first outer conductor 23A and the second outer conductor 23B with the inner conductors 23C.

The above-described embodiment may be practiced in various manners as exemplified below.

The multilayer wiring board 21 of the primary coil C1 only needs to include one layer of the first outer conductor 23A, one layer of the second outer conductor 23B and at least one layer of the inner conductor 23C. The number of layers of the inner conductors 23C is not specifically limited.

The manner of connection among the conductors 42 of the multilayer wiring boards 21 is not specifically limited. All the conductors 42 may be connected either in series or in parallel. Alternatively, the conductors 42 may be a mixture of series-connected conductors 42 and parallel-connected conductors 42.

The structure of the conductors 42 of the multilayer wiring board 21 is not specifically limited. Each conductor 42 may be formed in a spiral shape having two or more turns. Alternatively, the conductor 42 may be formed by punching a metal sheet such as a copper sheet. Alternatively, pattern printing may be applied to the insulating sheet 41.

The number of multilayer wiring boards 21 that form the primary coil C1 may be of any number as long as it is two or more.

The manner of connection among the multilayer wiring boards 21 of the primary coil C1 is not specifically limited. All the multilayer wiring boards 21 may be connected either in series or in parallel.

The primary coil C1 may be formed by a combination of the same multilayer wiring boards 21. Alternatively, the primary coil C1 may be formed by a combination of the multilayer wiring boards 21 having different number of turns of the conductor 42 or different number of layers of the conductor 42.

The structure for electrically connecting the multilayer wiring boards 21 of the primary coil C1 is not specifically limited. The multilayer wiring boards 21 may be electrically connected together by joining the external terminals 25 of the multilayer wiring boards 21 with solder.

The coil structure formed by laminating and electrically connecting together the multilayer wiring boards 21 may be applied to the secondary coil C2 of the transformer or to both of the coils C1 and C2.

The material and shape of the magnetic core 10 are not specifically limited. The magnetic core 10 may be of a U-I core, an E-E core or a U-U core. A gap may be formed between the cores.

Although the induction device is applied to the transformer, it may be applied to any other induction devices such as a reactor. The induction device may be suitably used for an electric vehicle or a hybrid vehicle.

What is claimed is:

1. An induction device comprising:
a magnetic core; and
a coil formed around the magnetic core by laminating and electrically connecting together a plurality of multilayer wiring boards, each multilayer wiring board having a hole through which the magnetic core is inserted, wherein each multilayer wiring board includes a first outer conductor, an inner conductor and a second outer conductor that are laminated together with an insulating layer disposed between the first outer conductor and the inner conductor and also the insulating layer disposed between the inner conductor and the second outer conductor, wherein the first outer conductor, the inner conductor and the second outer conductor are formed around the hole of the multilayer wiring board, wherein the first outer conductor and the second outer conductor are connected to the inner conductor.

2. The induction device according to claim 1, wherein at least two of the multilayer wiring boards are connected in series.

3. The induction device according to claim 1, wherein at least two of the multilayer wiring boards are connected in parallel.

4. The induction device according to claim 1, wherein at least two of the multilayer wiring boards are connected in series and at least two of the multilayer wiring boards are connected in parallel.

5. The induction device according to claim 1, wherein the first outer conductor and the second outer conductor are electrically connected to the inner conductor via a through hole.
